(19) United States
(12) Patent Application Publication
(10) Pub. No.: US 2014/0193672 A1
(43) Pub. Date: Jul. 10, 2014

(54) THERMAL TO ELETRIC CONVERTING CELL

(71) Applicant: KOREA INSTITUTE OF ENERGY RESEARCH, Daejeon (KR)

(72) Inventors: Sun-Dong KIM, Daejeon (KR); Se-Young KIM, Seongnam-si (KR); Sang-Kuk WOO, Daejeon (KR); Jong-Hoon JOO, Chungcheongbuk-do (KR); In-Sub HAN, Daejeon (KR); Doo-Won SEO, Daejeon (KR); Min-Soo SUH, Daejeon (KR)

(73) Assignee: KOREA INSTITUTE OF ENERGY RESEARCH, Daejeon (KR)

(21) Appl. No.: 13/958,690

(22) Filed: Aug. 5, 2013

(30) Foreign Application Priority Data
Jan. 4, 2013 (KR) 10-2013-0000867

(51) Int. Cl. H02N 3/00; H01M 2/10

(52) U.S. Cl. CPC H02N 3/00; H01M 2/10
USPC 429/11; 29/25.03

(57) ABSTRACT

Disclosed are a metal support thermal to electric converting cell, a thermal to electric power generator using the same, and a method for manufacturing the thermal to electric converting cell. Unlike a conventional method for manufacturing the thermal to electric converting cell by sintering a solid electrolyte, a method provided by the present invention is to manufacture the thermal to electric converting cell by coating a metal support capable of collecting electricity and functioning as an electrode with the solid electrolyte in the form of a high density thin film, so that the cell has durability and stability at a high temperature and a high pressure and has improved efficiency due to the thin film structure.

### BACKGROUND

1. Field

The present invention relates to a thermal to electric converting cell, and more particularly to a thermal to electric converting cell which is made by a process in which, after a tube is formed through use of a porous metallic material, a Beta-Alumina Solid Electrolyte (BASE) layer is coated on the surface of the tube, instead of a process in which Na ionic conductive ceramic such as a conventional BASE is sintered in the form of a tube, and a method for manufacturing the thermal to electric converting cell.

2. Description of Related Art

Alkali Metal Thermal to Electric Converter (AMTEC) is a thermal to electric power generator capable of generating electrical energy from thermal energy. When a temperature difference is given to both ends of an ionically conductive Beta-Alumina Solid Electrolyte (BASE), Na charged in the cell is ionized into Na+ due to the vapor pressure difference of Na, and then is neutralized. Electricity is generated during this process. In this case, low voltage and high current are generated. So, when the cells are modularized by being connected in series or in parallel, a large amount of electric power can be generated.

The development of alkali metal thermal to electric converter (AMTEC) technology has started for the purpose of an electric power source for space. The AMTEC has a high power density per unit area and high efficiency, and maintains stability. The AMTEC uses a variety of heat sources, for example, solar energy, fossil fuel, waste heat, terrestrial heat, nuclear reactor, etc. The AMTEC is comprised of electric power generation cells capable of generating electricity without using a driver such as a turbine, a motor or the like, so that it can directly generate electricity from a portion contacting with the heat. When the AMTEC is formed in the form of a module in series or in parallel, a great amount of electricity of several KW to several hundredths MW can be generated. At present, through a technology of collecting the waste heat, the waste heat is collected in the form of heat water, combustion air, etc., by using a heat exchanger, a waste heat boiler or the like. The AMTEC is capable of improving the efficiency by directly generating high-quality electricity. Therefore, the AMTEC is now issued as a promising technology replacing the existing technologies.

The process of generating electricity in the AMTEC will be specifically described. After the state of Na vapor is changed into a vapor state in a high temperature and high pressure evaporator by a heat source, Na+ passes through beta-alumina solid electrolyte (BASE), and free electrons return to a cathode through an electric load from an anode, and then are recombined with ion generated from the surface of a low temperature and low pressure BETA and then is neutralized. Electricity is generated during this process.

The vapor pressure of Na plays the most significant role in a thermal to electric power generator as an energy source or a driving force which generates electricity. Also, free electrons generated during a process in which Na passes through the solid electrolyte due to a concentration difference and temperature difference of a working fluid are collected through electrodes, so that electricity can be generated.

The beta-alumina and Na super-ionic conductor (NASICON) may be used as the solid electrolyte. The beta-alumina includes two kinds of beta′-alumina and beta″-alumina. The beta″-alumina has a more improved layer structure so that the conductivity of the Na+ ion is much better. Therefore, the beta″-alumina is now generally used.

A process is repeated in which the neutral Na vapor is condensed by being cooled on the inner surface of a low pressure condenser and is transferred to an evaporator by a capillary wick, and then is changed into a vapor state again. Generally, the temperature of the evaporator is in a range of 900 K to 1,100 K, and the temperature of the condenser in a range of 500 K to 600 K. It is possible for the efficiency of the thermal to electric power generation of the AMTEC to be up to 40%.

### PRIOR ART DOCUMENT

In the publication of Korean Patent Application No. 10-2012-0062279, disclosed is a method for manufacturing a Beta-Alumina Solid Electrolyte (BASE). The method includes: crushing mechanically a mixture including a solvent and a compound containing Al(OH)₃ and Na; performing a heat treatment on the mixture at a temperature of 500° C. to 900° C.; and sintering the mixture. The method makes it possible to sinter at a low temperature and restrains Na from being volatilized, so that the BASE having high density and low porosity is manufactured. However, regarding the above-mentioned method, when a resistance is reduced by reducing the thickness of the solid electrolyte, the mechanical strength of the sintered body is decreased, so that it is in danger of being destroyed. Moreover, there is a limit to make the solid electrolyte to be manufactured thinner.

### SUMMARY

### Technical Problem

A conventional thermal to electric converting cell has been manufactured by the following process. After conductive ceramic like a Beta-Alumina Solid Electrolyte (BASE), etc., is sintered in the form of a tube, a unit cell is formed by forming such an electrode as Mo, TiN, RuO or Ru₂O inside and outside the conductive ceramic. Then, the unit cells are multiple-bonded to a-alumina/metal, so that the conventional thermal to electric converting cell is obtained. It is necessary that the solid electrolyte should be thin for the purpose of reducing the resistance and should also have high density for the purpose of increase the strength and durability. For this reason, when the BASE is formed to be thin, the mechanical strength of the sintered body is decreased, so that the BASE is in danger of being destroyed during the manufacture and operation thereof. Also, with regard to a current ceramic process, there is a limit to reduce the thickness of the solid electrolyte, and it is difficult to collect electricity inside the tube or to form a stack, while it is easy to collect electricity outside the tube. Additionally, regarding a solid state reaction in which oxide powders such as Na₂O, Al₂O₃, etc., are mixed and sintered, the porosity is increased due to a low sintered density, so that the electrical characteristics are degraded. Since the solid state reaction includes high temperature synthesis, a large amount of Na is volatilized, so that it is difficult to make exact composition.

In addition, research has been conducted to find whether or not Na super-ionic conductor (NASICON) popular to have excellent cation conduction is used as a solid electrolyte material for high temperature. However, the NASICON has a problem in its stability of crystal structure when it is exposed to high temperature for a long time.

In order to overcome the problems, after the porous metal tube is manufactured, the beta alumina solid electrolyte or the Na super-ionic conductor (NASICON) solid electrolyte is coated on the surface of the tube in the form of a thin film, so that the resistance of the solid electrolyte is reduced and both the strength and durability of the solid electrolyte are enhanced. As a result, the performance of the solid electrolyte is improved.

### Technical Solution

One aspect of the present invention is a method for manufacturing a thermal to electric converting cell. For the purpose of overcoming the above-mentioned problems, after a porous metal tube is manufactured, a solid electrolyte layer is coated on the surface of the tube in the form of a thin film, so that the thermal to electric converting cell is manufactured. A thermal spray coating process and a plasma coating process are used to form the solid electrolyte on the porous metal support. Ceramic powder is molten at a high temperature and then is sprayed through a nozzle, so that the porous metal support is coated with a high density without a separate sintering process. As a result, destruction of the solid electrolyte layer does not occur in a metal-reduction atmosphere, ceramic-oxidation atmosphere and during a heat treatment process caused by a thermal expansion coefficient difference.

### Advantageous Effects

The present invention employs a coating process for the purpose of forming a solid electrolyte layer on a porous metal support in manufacturing a thermal to electric converting cell. Therefore, a heat treatment process is not required, so that the porous structure of the metal support can be maintained as it is. Also, since a conventional high temperature sintering process is not required, so that the manufacturing cost thereof can be reduced. The coating process includes a thermal spray coating process or a plasma coating process. Then, it is possible to control the thickness, composition and density of the solid electrolyte layer, and also possible to improve the efficiency by increasing the density simultaneously with reducing the thickness. The metal support can be used as an internal electrode. Therefore, internally collecting electricity is allowed without loss and the metal support is easily joined because the support is made of a metallic material. Since the solid electrolyte is formed on the metal support in the form of a film, an internal pressure can be increased. The solid electrolyte has stability against an operating pressure and has durability against thermal shock generated during the operation process of the thermal to electric conversion. Accordingly, the solid electrolyte is resistant to the heat and mechanical shock, so that the thermal to electric converting cell is in less danger of being destroyed and has improved durability and stability. Since the solid electrolyte is formed in the form of a thin film, resistance is reduced and the efficiency is enhanced. Further, by using the thermal to electric converting cell, it is possible to manufacture a power generator without a motor, engine and driver, and also possible to manufacture a power generator which has less noise, is light and economical and has high efficiency.

### BRIEF DESCRIPTION OF THE DRAWINGS

FIG. 1 is a view showing a configuration of a thermal to electric converting cell of the present invention;

FIG. 2 is a view showing a configuration of a cross section of the thermal to electric converting cell of the present invention;

FIG. 3 is a view showing a principle of a unit thermal to electric power generator;

FIG. 4 is a view showing an operating principle of a power generating unit which controls electricity generated by connecting wires to a porous electrode and a metal support of the thermal to electric converting cell;

FIG. 5 is a view showing a configuration of an embodiment of the thermal to electric converting cell and a joiner;

FIG. 6 is a view showing a configuration of an embodiment of the thermal to electric power generator;

FIG. 7 is a view showing an operating principle of the thermal to electric power generator;

FIG. 8 is a flowchart showing, step by step, a method for manufacturing a metal support thermal to electric converting cell which includes a thin-film solid electrolyte coating layer; and

FIG. 9 is a flowchart showing, step by step, a method for manufacturing a metal support thermal to electric converting cell which includes a thin-film solid electrolyte coating layer.

### DETAILED DESCRIPTION

Embodiments of a metal support thermal to electric converting cell, a method for manufacturing the same and a thermal to electric power generator including the thermal to electric converting cell will be described with reference to the accompanying drawings.

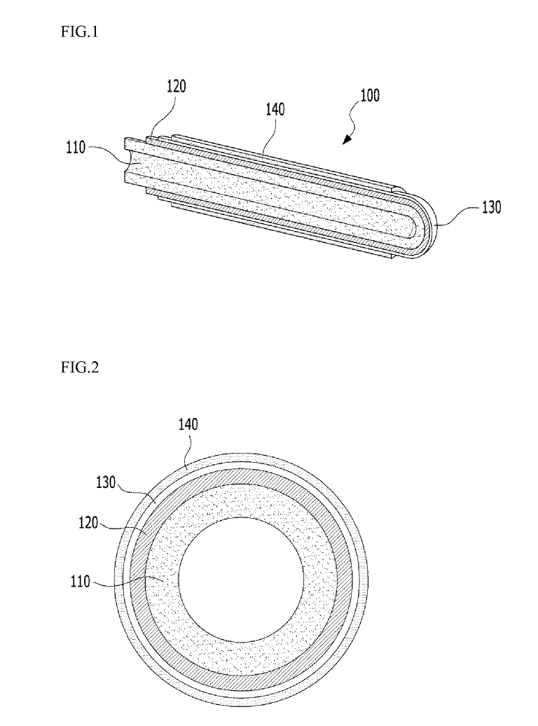

FIG. 1 is a view showing a configuration of a metal support thermal to electric converting cell 100 of the present invention. FIG. 2 is a view showing a configuration of a cross section of the metal support thermal to electric converting cell 100 of the present invention. The thermal to electric converting cell 100 includes a tubular metal support 110, a porous electrode functional layer 120, a solid electrolyte 130 formed on the surface of the metal support, and a porous electrode 140 formed on the surface of the solid electrolyte. Here, the thermal to electric converting cell 100 may be formed without the porous electrode functional layer 120 because the metal support 110 is able to collect electricity and to function as an electrode. Therefore, the metal support thermal to electric converting cell 100 may include the tubular metal support 110, the solid electrolyte 130 formed on the surface of the metal support, and the porous electrode 140 formed on the surface of the solid electrolyte.

The materials of the porous electrode functional layer 120 and the porous electrode 140 may include at least any one of molybdenum, nickel, aluminum, PtW, RhW, TiC, TiN, SiN, RuO and Ru₂O, and are not limited to this.

A porous metal support is used as the metal support 110 of the thermal to electric converting cell 100. The material of the porous metal support may include at least any one of molybdenum, titanium, tungsten, copper, nickel, nickel-iron alloy, stainless steel, iron and bronze, and preferably, the molybdenum which has a high melting point and thus is suitable for being used in a high temperature environment may be used. However the material of the porous metal support is not limited to this.

In the past, the solid electrolyte has been sintered without using the metal support 110. Therefore, the reduction of the thickness of the solid electrolyte has caused the durability and stability to be decreased. Since the solid electrolyte is formed after forming the metal support 110, the solid electrolyte 130 can be formed in the form of a thin film. When the solid electrolyte 130 is formed in the form of a thin film, a resistance can be reduced and consequently the efficiency is improved. Also, by using the metal support, the durability and stability are enhanced, so that the overall performance thereof is improved.

Beta-alumina or Na super-ionic conductor (NASICON) may be used as the solid electrolyte 130. The beta-alumina includes two kinds of beta′-alumina and beta″-alumina. The beta″-alumina has a more improved layer structure so that it has a higher conductivity and thus is generally used. Recently, research to use the beta-alumina as the solid electrolyte by adding a specific element to the beta-alumina is being done, so that not only the beta-alumina itself but also the beta-alumina solid electrolyte to which the specific element has been added is being used. The NASICON has excellent cation conductivity and is being researched as a high temperature solid electrolyte.

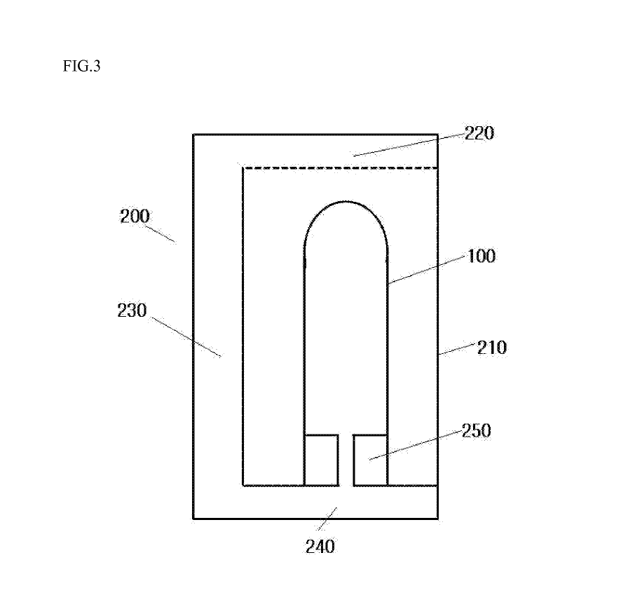

FIG. 3 is a view showing a principle of a unit thermal to electric power generator including the metal support thermal to electric converting cell. The unit thermal to electric power generator 200 includes the thermal to electric converting cell 100; a case 210; a working fluid which is disposed within the case and generates electricity during passing through the thermal to electric converting cell; a condensing unit 220 which is disposed on the upper portion of the case and collects and condenses the working fluid which has passed through the thermal to electric converting cell; an evaporator 240 which is disposed on the lower portion of the case, converts the working fluid into vapor by transferring heat to the working fluid and then transfers the working fluid vapor to the thermal to electric converting cell; a circulator 230 which connects the space the condensing unit 220 to the space of the evaporator 240 to thereby allow the working fluid to be transferred; and a joiner 250 which joins the evaporator 240 to the thermal to electric converting cell 100.

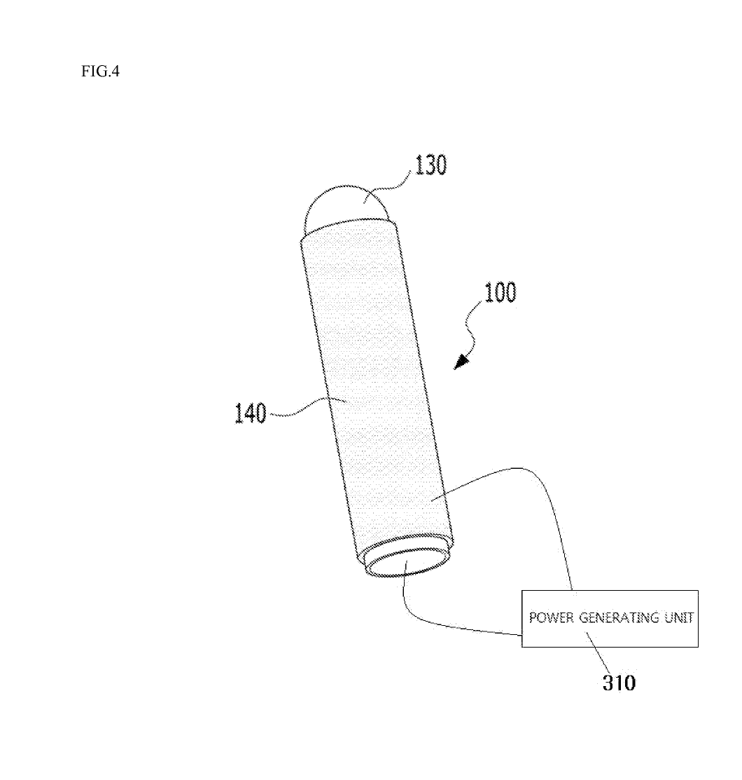

The thermal to electric power generator 200 further includes a heat source heating the lower portion of the case 210. Thanks to the heat transferred from the heat source, electrical energy can be generated within the thermal to electric power generator 200. Here, as shown in FIG. 4, a power generating unit 310 is electrically connected to the electrode 140 and the metal support 110 and controls electricity generated in the thermal to electric converting cell 100 of the thermal to electric power generator 200. The joiner 250 which joins the evaporator 240 to the thermal to electric converting cell 100 is formed of an electrical insulating material, so that free electrons generated in the thermal to electric converting cell 100 flow to the power generating unit 310. Here, as shown in FIG. 5, the joiner 250 includes an insulating alpha-alumina 251 and a metal tube 252 for improving joinability. The joiner 250 is also not limited to this.

Alkali metal is used as the working fluid. Here, the alkali metal may include any one of Na, K and Li and is not limited to this. When Na is used as the working fluid, the temperature of the evaporator reaches 1,100K, and the temperature of the condenser reaches 650K. When K having a lower melting point is used as the working fluid, the operating temperatures can be reduced as much as 120K respectively. Therefore, although theoretical themodynamic efficiency becomes higher when K is used as the working fluid, Na is generally used as the working fluid due to the problems in practical application

The condensing unit 220 includes a condenser 221 and a capillary wick 222. The working fluid condensed in the condensing unit 220 moves to the evaporator 240 along the capillary circulation wick 231 of the circulator 230, so that the working fluid comes to circulate.

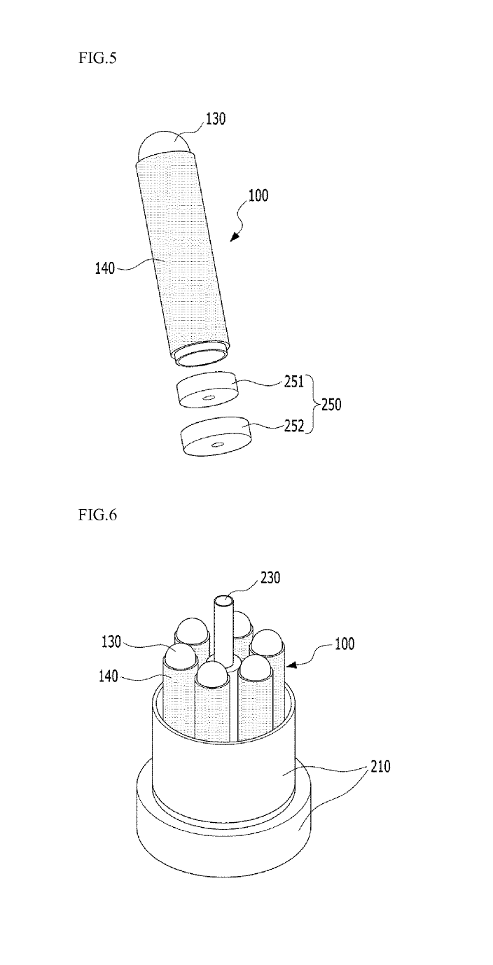

FIG. 6 is a view showing a configuration of a thermal to electric power generator 300 including a plurality of the thermal to electric converting cells 100. The thermal to electric power generator 300 includes a plurality of the thermal to electric converting cells 100; the case 210; the working fluid; the condensing unit 220 which is disposed on the upper portion of the case and collects and condenses the working fluid which has passed through each of the thermal to electric converting cells 100; the evaporator 240 which is disposed on the lower portion of the case, converts the working fluid into vapor by transferring heat to the working fluid and then transfers the working fluid vapor to each of the thermal to electric converting cells 100; the circulator 230 which connects the space the condensing unit 220 to the space of the evaporator 240 to thereby allow the working fluid to be transferred; the joiner 250 which joins the evaporator 240 to each of the thermal to electric converting cells 100; the power generating unit 310 to which the electrode 140 and the metal support 110 have been electrically connected controls electricity generated in each of the thermal to electric converting cells 100; and the heat source heating the lower portion of the case.

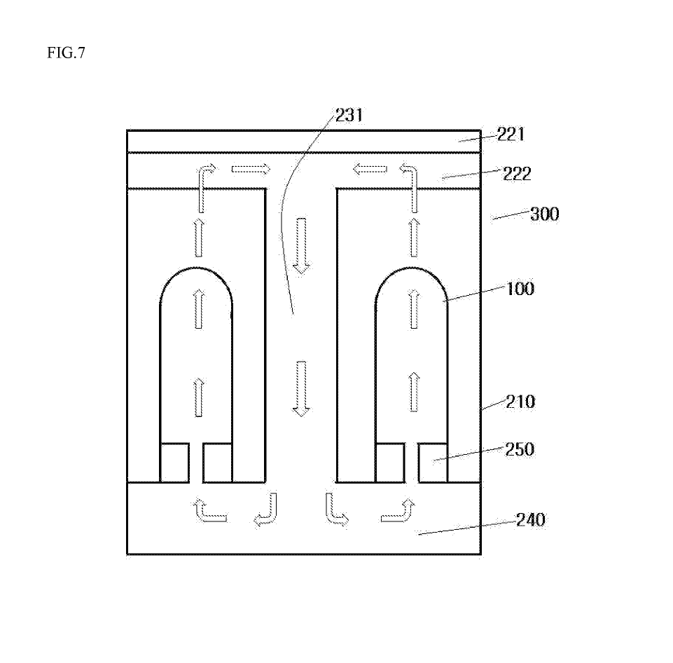

FIG. 7 is a view showing an operating principle of the thermal to electric power generator 300. When heat is transferred from the heat source to the thermal to electric power generator 300, the working fluid comes to circulate the inside of the thermal to electric power generator 300. More specifically, the vapor pressure of the working fluid is increased by the energy of the heat source, and the concentration difference and the temperature difference of the working fluid occur inside and outside the thermal to electric converting cell 100. Here, by using the differences as a driving force, electricity is generated during a process in which the working fluid passes through the solid electrolyte 130 of each of the thermal to electric converting cells 100. The working fluid which has passed through the thermal to electric converting cell 100 is circulated in such a manner as to be condensed in the condensing unit 220 and is transferred to the evaporator 240 through the capillary circulation wick 231 and then to be transferred from the evaporator 240 to each of the thermal to electric converting cells 100.

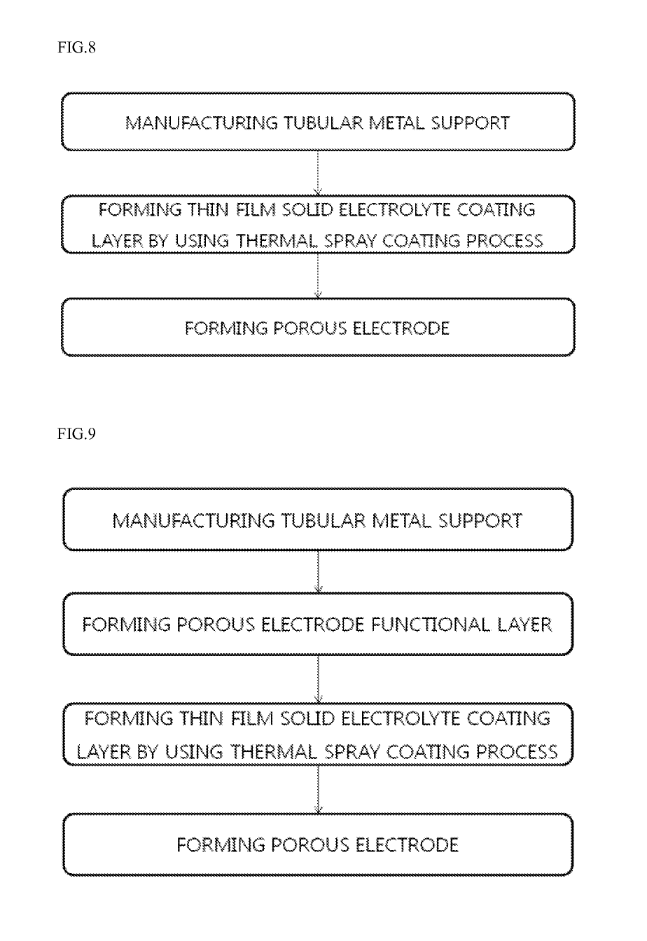

FIG. 8 is a flowchart showing, step by step, a method for manufacturing the thermal to electric converting cell 100 without the electrode functional layer 120. The method includes: manufacturing the tubular metal support formed of a metallic material; forming the solid electrolyte coating layer on the surface of the metal support in the form of a thin film by using a coating process; and forming the porous electrode on the surface of the solid electrolyte coating layer.

FIG. 9 is a flowchart showing, step by step, a method for manufacturing the thermal to electric converting cell 100 including the electrode functional layer 120. The method includes: manufacturing the tubular metal support formed of a metallic material; forming the porous electrode functional layer on the surface of the metal support; forming the solid electrolyte coating layer on the surface of the porous electrode functional layer in the form of a thin film by using a coating process; and forming the porous electrode on the surface of the solid electrolyte coating layer.

Here, in the forming the solid electrolyte coating layer, the coating layer may be formed in the form of a thin film by using any one of a thermal spray coating process and a plasma coating process. While it is preferable to use the thermal spray coating process to form the coating layer in the form of a thin film, there is no limit to this embodiment. The beta-alumina or Na super-ionic conductor (NASICON) may be used as the solid electrolyte. While it is preferable to use the beta″-alumina solid electrolyte, there is no limit to this embodiment.

The metal support is the porous metal support. The material of the porous metal support includes at least any one of molybdenum, titanium, tungsten, copper, nickel, nickel-iron alloy, stainless steel, iron and bronze. It is preferable to employ the molybdenum because the molybdenum can be manufactured in the form of a tube, has a high melting point and thus is maintained stable at a high temperature, and is economical in terms of price. However there is no limit to this embodiment.

The materials of the porous electrode functional layer 120 and the porous electrode 140 may include at least any one of molybdenum, nickel, aluminum, PtW, RhW, TiC, TiN, SiN, RuO and Ru₂O, and are not limited to this.

The present invention has been described with reference to the accompanying drawings. This is just one of various embodiments including the subject matter of the present invention and intends to allow those skilled in the art to easily embody the present invention. It is clear that the present invention is not limited to the above-described embodiments. Therefore, the scope of the present invention should be construed by the following claims. Without departing from the subject matter of the present invention, all the technical spirits within the scope equivalent to the subject matter of the present invention is included in the right scope of the present invention by the modifications, substitutions, changes and the like. Also, it is clear that some of the drawing configuration are intended for more clearly describing the configuration and are more exaggerated or shortened than the actual one.

What is claimed is:

1. A metal support thermal to electric converting cell comprising:
a tubular metal support;
a solid electrolyte formed on the surface of the metal support; and
a porous electrode formed on the surface of the solid electrolyte.

2. The metal support thermal to electric converting cell of claim 1, further comprising a porous electrode functional layer between the metal support and the solid electrolyte.

3. The metal support thermal to electric converting cell of claim 2, wherein a material of the porous electrode functional layer comprises at least any one of molybdenum, nickel, aluminum, PtW, RhW, TiC, TiN, SiN, RuO and Ru₂O.

4. The metal support thermal to electric converting cell of claim 1, wherein the metal support is a porous metal support.

5. The metal support thermal to electric converting cell of claim 4, wherein a material of the porous metal support comprises at least any one of molybdenum, titanium, tungsten, copper, nickel, nickel-iron alloy, stainless steel, iron and bronze.

6. The metal support thermal to electric converting cell of claim 5, wherein the solid electrolyte is a beta alumina solid electrolyte or a Na super-ionic conductor (NASICON) solid electrolyte, and wherein the solid electrolyte is formed in the form of a thin film.

7. The metal support thermal to electric converting cell of claim 6, wherein a material of the porous metal support comprises molybdenum, nickel, aluminum, PtW, RhW, TiC, TiN, SiN, RuO and Ru₂O.

8. A metal support unit thermal to electric power generator comprising:
the thermal to electric converting cell of claim 7;
a case;
a working fluid which is disposed within the case;
a condensing unit which is disposed on the upper portion of the case and collects and condenses the working fluid which has passed through the thermal to electric converting cell;
an evaporator which is disposed on the lower portion of the case, converts the working fluid into vapor by transferring heat to the working fluid and then transfers the working fluid vapor to the thermal to electric converting cell;
a circulator which connects the space the condensing unit to the space of the evaporator to thereby allow the working fluid to be transferred; and
a joiner which joins the evaporator to the thermal to electric converting cell.

9. The unit thermal to electric power generator of claim 8, wherein the thermal to electric power generator further comprises a heat source heating the lower portion of the case.

10. The unit thermal to electric power generator of claim 9, further comprising a power generating unit which is electrically connected to the electrode and the metal support, and controls electricity generated in the thermal to electric converting cell of the unit thermal to electric power generator.

11. The unit thermal to electric power generator of claim 10, wherein the joiner of the unit thermal to electric power generator is formed of an electrical insulating material such that the electricity generated in the thermal to electric converting cell flows to the power generating unit.

12. The unit thermal to electric power generator of claim 11, wherein the joiner comprises:
an insulating alpha-alumina; and
a metal tube for improving joinability.

13. The unit thermal to electric power generator of claim 8, wherein the working fluid is an alkali metal.

14. The unit thermal to electric power generator of claim 13, wherein the alkali metal comprises at least any one of Na, K and Li.

15. The unit thermal to electric power generator of claim 8, wherein the condensing unit comprises a capillary wick and a condenser.

16. A thermal to electric power generator comprising;
a plurality of the thermal to electric converting cells of claim 7;
a case;
a working fluid which is disposed within the case;
a condensing unit which is disposed on the upper portion of the case and collects and condenses the working fluid which has passed through the thermal to electric converting cell; an evaporator which is disposed on the lower portion of the case, converts the working fluid into vapor by transferring heat to the working fluid and then transfers the working fluid vapor to the thermal to electric converting cell;
a circulator which connects the space the condensing unit to the space of the evaporator to thereby allow the working fluid to be transferred;
a joiner which joins the evaporator to the thermal to electric converting cell;
a power generating unit which is electrically connected to the electrode and the metal support, and controls electricity generated in each of the thermal to electric converting cells; and
a heat source which heats the lower portion of the case.

17. A method for manufacturing the metal support thermal to electric converting cell of claim 1, the method comprising:
(i) manufacturing the tubular metal support formed of a metallic material;
(ii) forming the solid electrolyte coating layer on the surface of the metal support in the form of a thin film by using a coating process; and
(iii) forming the porous electrode on the surface of the solid electrolyte coating layer.

18. A method for manufacturing the metal support thermal to electric converting cell of claim 2, the method comprising:
(i) manufacturing the tubular metal support formed of a metallic material;
(ii) forming the porous electrode functional layer on the surface of the metal support;
(iii) forming the solid electrolyte coating layer on the surface of the porous electrode functional layer in the form of a thin film by using a coating process; and
(iv) forming the porous electrode on the surface of the solid electrolyte coating layer.

19. The method for manufacturing the metal support thermal to electric converting cell of claim 17, wherein the forming the solid electrolyte coating layer is performed by using at least any one of a thermal spray coating and a plasma coating.
